(19) United States
(12) Patent Application Publication
(10) Pub. No.: US 2017/0013677 A1
(43) Pub. Date: Jan. 12, 2017

(54) HEATING PLATE FOR HEATED CLOTHING AND CONNECTING STRUCTURE OF THE SAME

(71) Applicant: MEC ADDHEAT CO., LTD., TAINAN CITY (TW)

(72) Inventor: CHIEN-CHOU CHEN, TAINAN CITY (TW)

(21) Appl. No.: 14/795,952

(22) Filed: Jul. 10, 2015

(51) Int. Cl. H05B 3/34; H05B 3/02

(52) U.S. Cl. CPC H05B 3/342; H05B 3/34; H05B 3/026

(57) ABSTRACT

This invention is related to a heating plate for a heated clothing and a connecting structure of the same. The heating plate comprises a heater strip which two ends are connected with two electric wires respectively, and each electric wire comprises sequentially a first right angle, a horizontal segment, a second right angle, and a vertical segment. The vertical segments of the electric wires go out from a covering piece which covers the heater strip and the electric wires. Therefore, when the electric wires of the heating plate are pulled, the pull strength is dispersed at the right-angle bend to be decreased, avoiding the heater strip moving. Furthermore, when the heating plate is set on the heated clothing, according to different size of the heated clothing, the length of an assembly electric wire is relative to the distance between the heating plates.

### BACKGROUND OF THE INVENTION

Field of the Invention

The present invention relates a heating plate for a heated clothing and a connecting structure of the same. More particularly, the disclosure relates to a heating plate and a connecting structure of the same that can avoid the heater strip being pulled to move and increase the assembled convenience.

Description of Related Art

After the heated clothing is used for a period of time to become dirty, it is usually washed and spun by a washing machine directly and is dried by a dry machine. However, the heated clothing is damaged seriously in the forging washing process. When the heated clothing is washed and spun by the washing machine, it is pulled irregularly by a strong strength caused by stirring of the washing machine. After the electric wires of the heating plate in the heated clothing are pulled by the strong strength, the heater strip connected to the electric wires is moved together. Although some producer use hot-melt adhesive to fix the heater strip in the heating intermediate layer, the melting point of the hot-melt adhesive is too low, resulting that the hot-melt adhesive is melted by the thermal energy produce by the heater strip, losing its fixed effect. Therefore, some producers stitch the heater strip 61 and the electric wires 62 onto the heating plate 6 by stitching wires 63 to keep the heater strip 61 and the electric wires 62 on the heating plate 6. It prevents the heater strip 61 from being pulled out of the heating plate 6 when the heater strip 61 is pulled, shown as FIG. 7. However, the stitch process expends manpower and time very much, it is not cost-effective.

Furthermore, the existing heated clothing is provided for customers with different physique, so the different sizes of the heated clothing are manufactured. The heating device in the existing heated clothing comprises one heating plate set at each front part and the back part respectively, and the each heating plate is connected together by an electric wire. The electric wire is also connected to a temperature control switch and a battery plug. In order to fit the different size of the heated clothing, the length of the electric wire for connection of the heating plates and the temperature control switch is relative to the biggest size of the heated clothing. However, when the foregoing design is applied to a smaller size of the heated clothing, the assembly process of the heating device is inconvenience because of the extra length of the electric wire. The over-length electric wire is twisted in the lining of the heated clothing, resulting that the twisted electric wire is broken easily under strong agitation and pull when the heated clothing is washed in the washing machine, affecting the life time of the heated clothing.

### SUMMARY OF THE INVENTION

Therefore, the object of the present invention is related to a heating plate for a heated clothing and a connecting structure of the same. More particularly, the disclosure relates to a heating plate and a connecting structure of the same that can avoid the heater strip being pulled to move and increase the assembled convenience.

For the above object, a heating plate comprises a heater strip which two ends are connected with two electric wires respectively, and each electric wire comprises sequentially a first right angle, a horizontal segment, a second right angle, and a vertical segment. The vertical segments of the electric wires go out from a covering piece which covers the heater strip and the electric wires. Therefore, when the electric wires of the heating plate are pulled, the pull strength is dispersed at the right angle bend to be decreased, avoiding the heater strip moving. Furthermore, when the heating plate is set on the heated clothing, according to different size of the heated clothing, the length of an assembly electric wire is relative to the distance between the heating plates. The assembled convenience is increased because of the properly length of the assembly electric wire, and it avoids the electric wires being broken because the length of the assembly electric wire is too long.

### BRIEF DESCRIPTION OF THE DRAWINGS

FIG. 1 is a front view of a heating plate according to an embodiment of the present invention;

FIG. 2 is a partial cross-sectional view of a heating plate according to an embodiment of the present invention;

FIG. 3 is a front view of a connecting structure of heating plates in a heated clothing according to an embodiment of the present invention;

FIG. 4 is a diagram of a connecting structure of heating plates in a heated clothing according to another embodiment of the present invention;

FIG. 5 is a front view of a connecting structure in a heated clothing according to another embodiment of the present invention;

FIG. 6 is a front view of a heating plate according to another embodiment of the present invention; and

FIG. 7 is a front view of a heating plate according to a prior art.

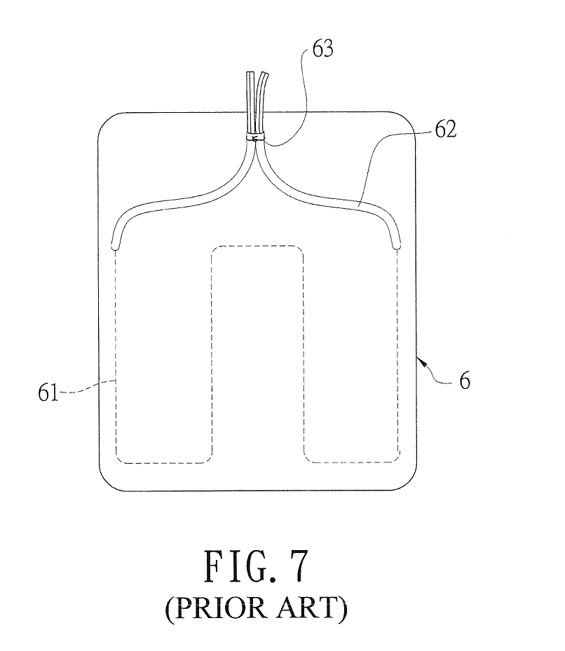

### DETAILED DESCRIPTION OF THE PREFERRED EMBODIMENT

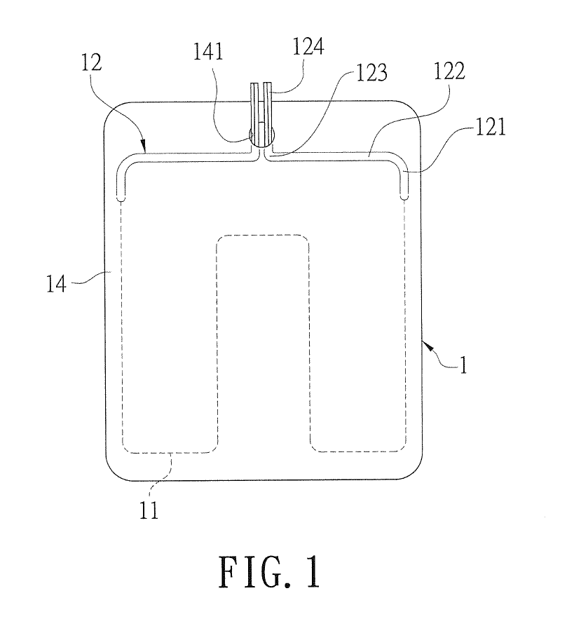

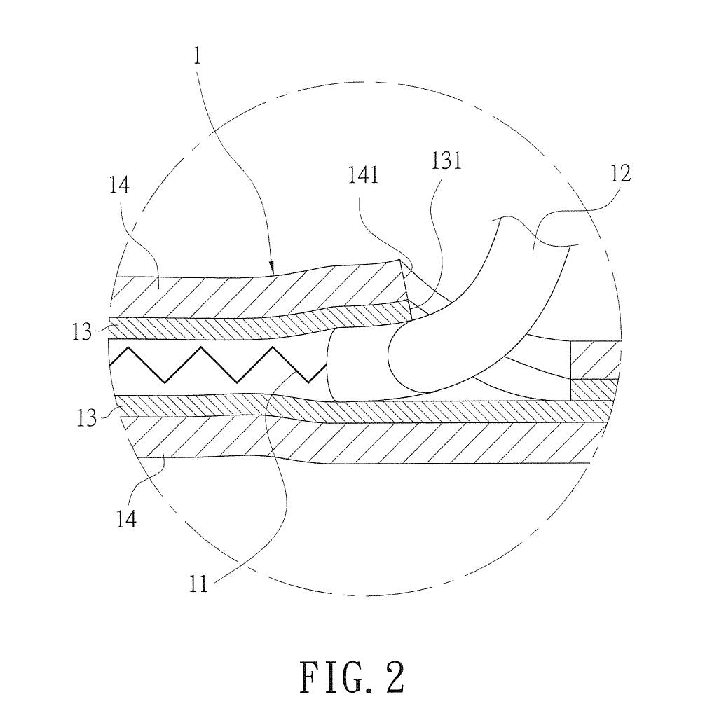

Please refer to FIG. 1 and FIG. 2. A heating plate 1 comprises a heater strip 11 and two electric wires 12 connected to the two ends of the heater strip 11 respectively. Each electric wire 12 comprises a first right angle 121, a horizontal segment 122 extended from the first right angle 121, a second right angle 123 bended from the other end of the horizontal segment 122, and a vertical segment 124 extended from the second right angle 123. The first right angles 121 of the two electric wires 12 are opposite to each other and the vertical segments 124 of the two electric wires 12 are converged at the central of the two electric wires 12. Two fixed layers 13 having a high melting point and formed as membrane are set at the two sides of the heater strip 11 and the electric wires 12. One of the fixed layers 13 is formed with an outlet 131 for the vertical segments 124 of the two electric wires 12 to go out, and the two fixed layers 13 are heat pressed so that the heater strip 11 and the electric wires 12 are held between the two fixed layers. Furthermore, two fabric covering pieces 14 are set at the outer surface of the two fixed layers 13 respectively, and one of the fabric covering pieces 14 is formed with an outlet 141 corresponding to the converged electric wires 12, so that the vertical segments 124 of the two electric wires 12 out from the fixed layer 13 are out from the outlet 141 of the covering piece 14. The periphery of the two covering pieces 14 is sealed together by sewing.

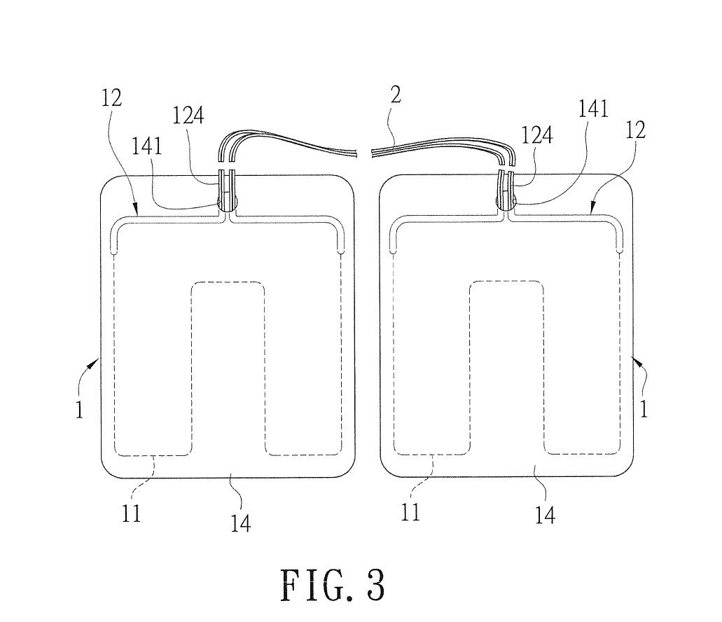

Please refer to FIG. 3. The vertical segments 124 of the two electric wires 12 of the heating plate 1 out from the covering piece 14 have fixed lengths, so that the heating plate 1 of the present invention is a fixed scale design. When the heating plates 1 of the present invention are assembled to a heated clothing, the length of an assembly electric wire 2 for connecting the heating plates 1 corresponds to the distance between the heating plates 1 according to different size of the heated clothing.

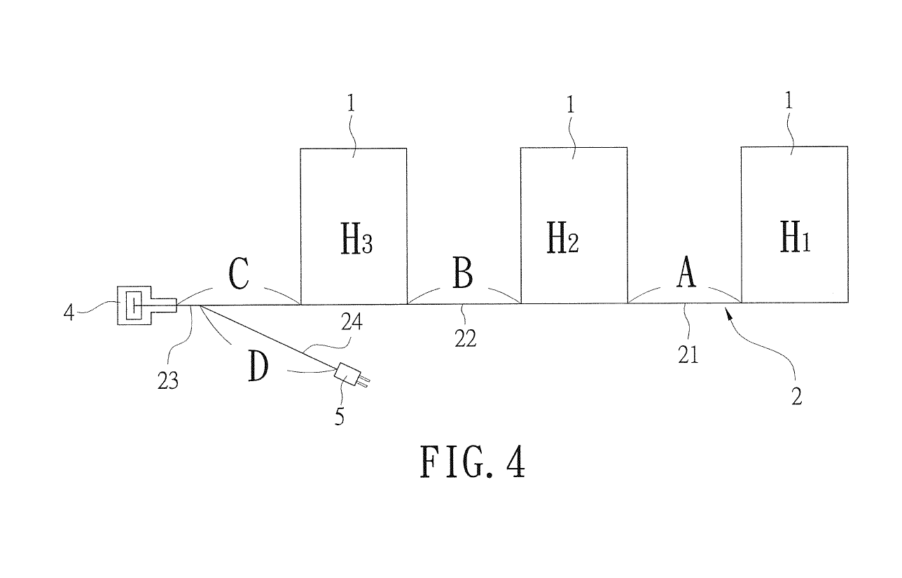

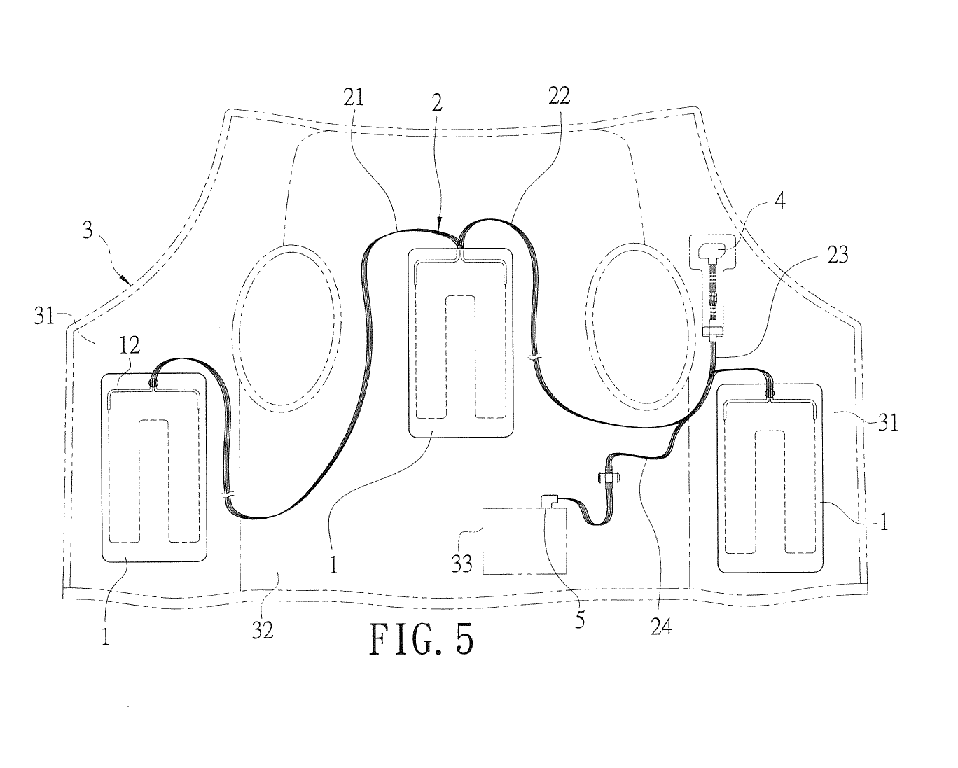

Please refer to FIG. 4 and FIG. 5. The example that the heating plate 1 of the present invention is assembled to a heated clothing 3 and the assembly electric wire 2 is connected with the heating plate 1, a temperature control switch 4, and a battery plug 5 is described below. Two front parts 31 and a back part 32 between the two front parts 31 of the heated clothing 3 are set with a heating plate 1, respectively. The lengths of the electric wires out from the covering piece 14 of each heating plate 1 are equal. The temperature control switch 4 is set on the one of the front parts 31 of the heated clothing 3. A battery pocket 33 is set on the heated clothing 3, and the battery plug 5 is set at the battery pocket 33. Several assembly electric wires 2 are connected among the heating plates 1, the temperature control switch 4, and the battery plug 5 and connected to the electric wires 12 of the heating plates 1, the temperature control switch 4, and the battery plug 5, so that a conducting circuit is formed among the connection among the heating plates 1, the temperature control switch 4, and the battery plug 5. The lengths of the assembly electric wires 2 are relative to the distance among the heating plates 1, the temperature control switch 4, and the battery plug 5 on the different size of the heated clothing 3.

In detail, the connecting structure is described below. If the distance between the heating plate 1 at the left front part 31 of the heated clothing 3 and the heating plate 1 at the back part 32 is A, the length of a first assembly wire 21 is A for connecting the electric wires 12 of the heating plates 1 at the left front part 31 and the back part 32 of the heated clothing 3. If the distance between the heating plate 1 at the back part 32 of the heated clothing 3 and the heating plate 1 at the right front part 31 of the heated clothing 3 is B, the length of a second assembly wire 22 is B for connecting the electric wires 12 of the heating plates 1 at the right front part 31 and the back part 32 of the heated clothing 3. The temperature control switch 4 is set on the right front parts 31 of the heated clothing 3, and the distance between the temperature control switch 4 and the heating plate 1 at the right front part 31 of the heated clothing 3 is C, so that the length of a third assembly wire 23 is C for connecting the electric wires of the heating plate 1 at the right front part 31 of the heated clothing 3 and the temperature control switch 4. The distance between the temperature control switch 4 and the battery plug 5 set at the battery pocket 33 is D, so that the length of a fourth assembly wire 24 is D for connecting the electric wires of the temperature control switch 4 and the battery plug 5. According to the different distance among the heating plates 1, the temperature control switch 4, and the battery plug 5 in different size of the heated clothing 3, a proper length of the assembly wires 2 are used to connect them.

Therefore, it avoids assembled inconvenience which is caused by the excess length of the assembly wire 2 during the assembly process for the heated clothing 3 and avoids the assembly wire 2 in the lining of the heated clothing 3 twisting due to the excess length of the assembly wire 2. When the heated clothing 3 is washed in a washing machine, the twisted wire is broken easily under strong agitation and pull by the washing machine. Utilization of the bending structure of the first right angle 121, the horizontal segment 122, the second right angle 123, and the vertical segment 124 of the two electric wires 12 in the heating plate 1 of the present invention, the pulling strength is dispersed at the second right angle 123 when the vertical segment 124 of the electric wires 12 in the heating plate 1 is pulled, so that the pulling strength only acts on the vertical segment 124 and the second right angle 123. Even if a few of strength is transformed to the horizontal segment 122, the strength is dispersed again at the second right angle 123. Accordingly, it efficiently avoids the heater stripe 11 connected to the electric wire 12 moving under pulling. Furthermore, the heater strip 11 and the electric wires 12 are fixed by the fixed layers 13 with a high melting point, the fixed effects of the heater strip 11 is further increased to prevent the heater strip 11 from moving, even from being pulled out of the heating plate 1.

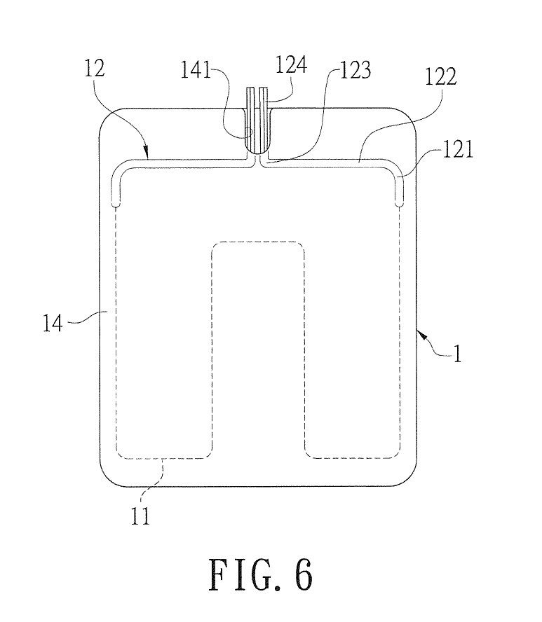

Please refer to FIG. 6, which is a front view of a heating plate for a heated clothing according to another embodiment of the present invention. The heating plate 1 is formed as membrane, and one of the fixed layers 13 is formed with an outlet 131 at the joint of the two electric wires 12 for the two electric wires 12 to go out from the outlet 131. And one of the covering pieces 14 is formed with an outlet 141, so that the two electric wires 12 out from the outlet 131 of the fixed layer 13 are out from the outlet 141 of the covering piece 14. The outlet 141 of the covering piece 14 is sewn to form an outlet for the convenience of the two electric wires 12 in the heating plate 1 to go out.

What is claimed is:

1. A heating plate for a heated clothing, comprising:
two covering pieces, wherein the periphery of the two covering pieces is sealed together and one of the covering pieces is formed with an outlet;
a heater strip, held between the two covering pieces; and
two electric wires, connected to the two ends of the heater strip respectively and held between the two covering pieces, each electric wire comprises:
a first right angle;
a horizontal segment, extended from the first right angle;
a second right angle, bended from the other end of the horizontal segment; and
a vertical segment, extended from the second right angle;
wherein the first right angles of the two electric wires are opposite to each other and the vertical segments of the two electric wires are converged at the central of the two electric wires and go out from the outlet.

2. The heating plate for the heated clothing according to claim 1, further comprising:
two fixed layers having a high melting point and formed as membrane, set between the two sides of the heater strip and the electric wires and the covering pieces respectively, wherein one of the fixed layers is formed with an outlet for the vertical segments of the two wires to go out and the two fixed layers are heat pressed so that the heater strip and the electric wires are held between the two fixed layers.

3. The heating plate for the heated clothing according to claim 2, wherein the outlets of the covering pieces and the fixed layers are holes or grooves.

4. The heating plate for the heated clothing according to claim 1, wherein the outlet of the covering piece is a hole or a groove.

5. A connecting structure in a heated clothing, comprising:
a heated clothing;
at least two heating plates, as claimed in claim 1, to be fitted on the heated clothing, wherein the lengths of the electric wires out from the outlet of the covering piece are equal; and
an assembly electric wire, set between the two heating plates and connected to the electric wires of the two heating plates, wherein the length of the assembly electric wire is relative to the distance between the two heating plates on the different size of the heated clothing.

6. A connecting structure in a heated clothing, comprising:
a heated clothing, comprising two front parts and a back part connected to the two front parts;
a battery pocket, on the heated clothing;
a plurality of heating plates for heated clothing according to claim 1, set on the two front parts and the back part of the heated clothing respectively, wherein the lengths of the electric wires out from the covering piece of each heating plate are equal;
a temperature control switch, set on the one of the front parts of the heated clothing;
a battery plug, set at the battery pocket of the heated clothing; and
a plurality of assembly electric wires, connected among the heating plates, the temperature control switch, and the battery plug and connected to the electric wires of the heating plates, the temperature control switch, and the battery plug, wherein the lengths of the assembly electric wires are relative to the distance among the heating plates, the temperature control switch, and the battery plug on the different size of the heated clothing.

7. The connecting structure in the heated clothing according to claim 6, wherein the assembly electric wires comprise:
a first assembly electric wire, wherein the length of the first assembly electric wire is relative to the distance between the heating plate set on the one of the front parts of the heated clothing and the heating plate set on the back part of the heated clothing;
a second assembly electric wire, wherein the length of the second assembly electric wire is relative to the distance between the heating plate set on the back part of the heated clothing and the heating plate set on the other of the front parts of the heated clothing;
a third assembly electric wire, wherein the length of the third assembly electric wire is relative to the distance between the temperature control switch on one of the front parts and the heating plate set on the same front part of the heated clothing; and
a fourth assembly electric wire, wherein the length of the fourth assembly electric wire is relative to the distance between the temperature control switch and the battery plug.
